(19) United States
(12) Patent Application Publication
(10) Pub. No.: US 2025/0210817 A1
(43) Pub. Date: Jun. 26, 2025

(54) INTERCONNECTORS FOR WIRE BONDING IN BATTERY PACK

(71) Applicant: TVS MOTOR COMPANY LIMITED, Chennai (IN)

(72) Inventors: Urvashi Singh, Chennai (IN); Pramila Rao Nileshwar, Chennai (IN)

(73) Assignee: TVS MOTOR COMPANY LIMITED, Chennai (IN)

(21) Appl. No.: 18/850,743

(22) PCT Filed: Mar. 6, 2023
(86) PCT No.: PCT/IN2023/050205

§ 371 Date: Sep. 25, 2024

(30) Foreign Application Priority Data
Mar. 26, 2022 (IN) 202241017519

(51) Int. Cl. H01M 50/503; H01M 50/507; H01M 50/516; H01M 50/522; H01M 50/583

(52) U.S. Cl. CPC H01M 50/503; H01M 50/507; H01M 50/516; H01M 50/522; H01M 50/583; H01M 2200/103

(57) ABSTRACT

An interconnector, for connecting a plurality of cells in a battery pack, includes: a main interconnect segment for connecting the plurality of cells, the main interconnect segment having a plurality of openings between a first end and a second end of the main interconnect segment, the plurality of openings being adapted to respective terminals of the plurality of cells in the battery pack; and a plurality of wire bonds connecting the main interconnect segment to the terminals of the plurality of cells, the respective plurality of wire bonds at one end being connected to the terminals of the respective plurality of cells, the respective plurality of wire bonds at another end being connected to a plurality of connecting portions on the main interconnect segment, the plurality of connecting portions being substantially close to the respective terminals of the plurality of cells.

### FIELD OF THE INVENTION

The present invention relates to battery packs and more particularly to interconnectors for connecting cells in battery packs.

### BACKGROUND OF THE INVENTION

It is known in the art to connect multiple cells such as Lithium-ion or Nickel metal hydride cells in series or parallel to obtain any desired voltage or current in a battery pack. For example, a set of cells may be arranged in parallel to obtain a desired current. Consequently, many of the parallel sets may be coupled in series to obtain a desired voltage of the larger set. The larger set may be electrically coupled in series or parallel with other similarly sized sets to obtain an even higher voltage or current.

In the prior art, resistive spot welding is used as a joining technique for electrically joining the cells to one another. The resistive spot-welding process has many disadvantages as it is time consuming and prone to failure. Further, the battery packs using spot welding are suitable for low power applications only. Though spot welding provides a low capex entry to manufacturing, it introduces multiple issues with respect to cell connections and thermal design.

With resistive spot welding, checking the quality of connection between each cell and the conductor is also difficult. Further, there is no provision for electrical protection. The problem of entire set of batteries becoming unusable because of malfunction or electrical shorting in a single cell has been a challenge in the prior art.

Further, the problem of short circuit becomes vicious and is aggravated in the arrangement of the prior art. A short circuit produces heat. This heat produced as result of shorting of some of the batteries can prove fatal for other non-shorted batteries. The batteries are closely packed in a battery pack and the non-shorted batteries also get over heated due to proximity to the other shorted batteries. An over heated battery is prone to explode and may prove catastrophic. Thus, a minor short circuit in just one of the batteries can prove catastrophic for the entire set and also the battery management system. Further, the heat produced as a result of the short circuit creates a cell temperature gradient in the battery pack leading to higher imbalance. Further, manual spot welding may show variation in quality.

Thus, there is a need in the art for providing a connection system for cells in a battery pack, which addresses at least the aforementioned problems.

### SUMMARY OF THE INVENTION

In one aspect, the present invention is directed at an interconnector for connecting a plurality of cells in a battery pack. The interconnector includes a main interconnect segment and a plurality of wire bonds. The main interconnect segment connects the plurality of cells. The main interconnect segment has a plurality of openings between a first end and a second end adapted to respective terminals of the plurality of cells in the battery pack. The plurality of wire bonds connects the main interconnect segment to the terminals of the plurality of cells. The respective plurality of wire bonds at one end are connected to the terminals of the respective plurality of cells and at another end are connected to a plurality of connecting portions on the main interconnect segment. The plurality of connecting portions are substantially close to the respective terminals of the plurality of cells.

In an embodiment, the interconnector has a signal output sub-segment at the first end of the main interconnect segment. The signal output subsegment is joined to the main interconnect segment and provides information related to a state of the plurality of cells. In an embodiment, the signal output sub-segment is made of Nickel and has means for connecting to an external monitoring instrument.

In another embodiment, the interconnector has a busbar segment running substantially parallel to the main interconnect segment. The busbar segment is joined to the main interconnect segment and extends towards and beyond the first end of the main interconnect segment for providing means for a power output of the plurality of cells. The interconnector also includes at least one twig portion connecting the main interconnect segment to the busbar segment. The at least one twig portion connects the main interconnect segment to the busbar segment at a first location on the main interconnect segment.

In a further embodiment, the plurality of openings of the interconnector includes a first set of plurality of openings and a second set of plurality of openings. The first set of plurality of openings is disposed in a substantially straight line and runs parallel to the second set of plurality of openings. The first set of plurality of openings is adapted to a respective right-side terminal of a first set of plurality of cells of the plurality of cells. The second set of plurality of openings is adapted to a respective left side terminal of a second set of plurality of cells of the plurality of cells. The left side terminal has a polarity opposite to that of the right-side terminal. The first set of plurality of cells and the second set of plurality of cells form an array of cells in the battery pack.

In another embodiment, each of the plurality of wire bonds is an electric fuse designed to disconnect/break when the current passing through any of the plurality of wire bonds exceeds a predefined current value. The predefined current value depends upon the dimensions and the material of the wire bonds.

In various embodiments, the interconnector is made up of more than one type of metal such as copper, nickel and the like.

### BRIEF DESCRIPTION OF THE DRAWINGS

Reference will be made to embodiments of the invention, examples of which may be illustrated in accompanying figures. These figures are intended to be illustrative, not limiting. Although the invention is generally described in context of these embodiments, it should be understood that it is not intended to limit the scope of the invention to these particular embodiments.

FIGS. 1A and 1B illustrate a schematic view of a battery pack, in accordance with an embodiment of the present invention, wherein

FIG. 1A illustrates the battery pack in a top view; and

FIG. 1B illustrates the battery pack in a perspective view.

FIGS. 2A-C illustrate an interconnector in various embodiments of the invention, wherein,

FIGS. 2A and 2B illustrate the interconnector in various views in accordance with an embodiment of the invention; and

FIG. 2C illustrates the interconnector in accordance with another embodiment of the invention.

FIG. 3A illustrates the interconnector in various views in accordance with an embodiment of the invention.

FIG. 3B illustrates the interconnector in various views in accordance with another embodiment of the invention.

### DETAILED DESCRIPTION OF THE INVENTION

The present invention relates to a battery pack. More particularly, the present invention relates to interconnectors for connecting cells in a battery pack.

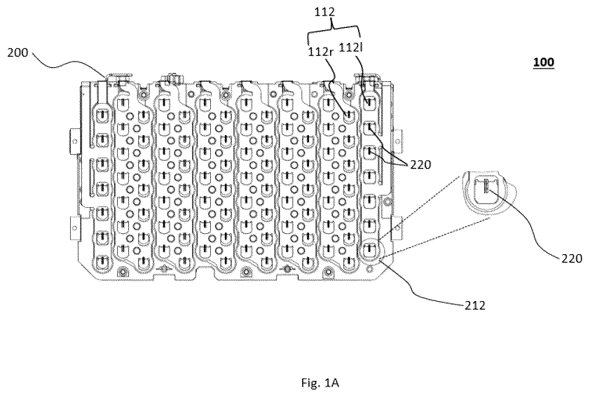

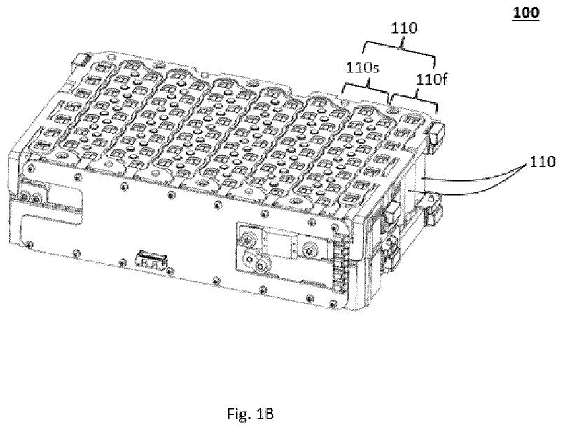

FIGS. 1A and 1B illustrate a schematic view of a battery pack 100, in accordance with an embodiment of the present invention. FIG. 1A illustrates the battery pack 100 in a top view and also shows a zoomed view of a part 212 of the interconnector. FIG. 1B illustrates the battery pack 100 in a perspective view. The battery pack includes a plurality of cells 110 arranged in an array to form the battery pack 100. The plurality of cells 100 are electrically coupled in series and then in parallel to achieve the desired voltage and current for the battery pack 100. A first set of plurality of cells 110f is arranged and electrically connected in parallel. Similarly, a second set of plurality of cells 110s is connected in parallel. The first set 110f is then electrically connected in series to the second set of plurality of cells 110s and so on. The electrical connection among the plurality of cells is achieved using a plurality of interconnectors 200.

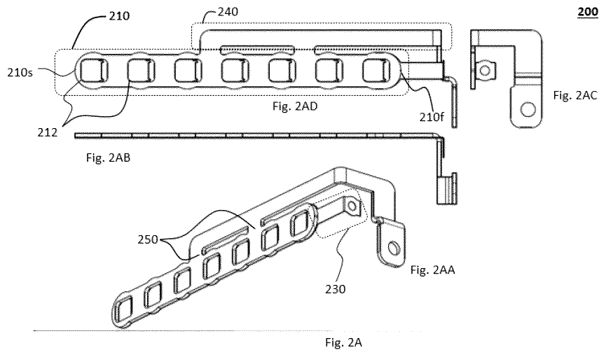

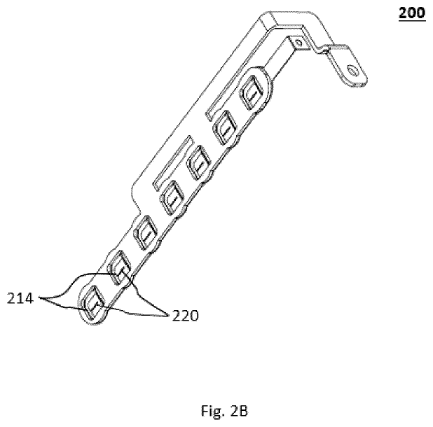

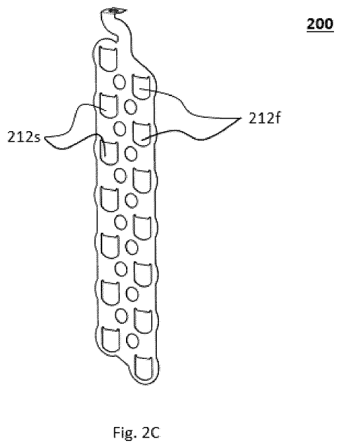

FIGS. 2A-C illustrate the interconnector 200 in various embodiments of the invention. FIGS. 2A and 2B illustrate the interconnector 200 in various views in accordance with an embodiment of the invention. FIG. 2AB illustrates the interconnector 200 in a front view. FIG. 2AC illustrates the interconnector 200 in a side view. FIG. 2AD illustrates the interconnector 200 in a top view. FIG. 2C illustrates the interconnector 200 in accordance with another embodiment of the invention. Referring to FIGS. 2A and 2B, the interconnector 200 includes a main interconnect segment 210 and a plurality of wire bonds 220. The main interconnect segment 210 connects the plurality of cells 110. The main interconnect segment 210 has a plurality of openings 212 between a first end 210f and a second end 210s of the main interconnect segment 210. The plurality of openings 212 are adapted to respective terminals 112 of the plurality of cells 110 in the battery pack 100.

The plurality of wire bonds 220 connect the main interconnect segment 210 to the terminals 112 of the plurality of cells 110. The respective plurality of wire bonds 220 at one end are connected to the terminals 112 of the respective plurality of cells 110 and at another end to a plurality of connecting portions 214 on the main interconnect segment 210. The plurality of connecting portions 214 are substantially close to the respective terminals 112 of the plurality of cells 110. Wire bonding is an ultrasonic, metal to metal friction welding process which takes place at room temperature and no external heat is necessary for welding.

In an embodiment, the interconnector 200 includes a signal output sub-segment 230 at the first end 210f of the main interconnect segment 210. The signal output subsegment 230 is joined to the main interconnect segment 210 and provides information related to a state of the plurality of cells 110. The signal output sub-segment 230 is made of Nickel and has means for connecting to an external monitoring instrument.

In an embodiment, the interconnector 200 includes a busbar segment 240 running substantially parallel to the main interconnect segment 210. The busbar segment 240 is joined to the main interconnect segment 210 and extends towards and beyond the first end 210f of the main interconnect segment 210 for providing means for a power output of the plurality of cells 110. The interconnector 200 also includes at least one twig portion 250 connecting the main interconnect segment 210 to the busbar segment 240. The at least one twig portion 250 connecting the main interconnect segment 210 to the busbar segment 240 at a first location on the main interconnect segment 210.

Referring to FIG. 2C, in an embodiment, the plurality of openings 212 includes a first set of plurality of openings 212f and a second set of plurality of openings 212s. The first set of plurality of openings 212f being disposed in a substantially straight line and running parallel to the second set of plurality of openings 212s. The first set of plurality of openings 212f are adapted to respective right-side terminals 112r shown in FIG. 1A of a first set of plurality of cells 110f of the plurality of cells 110. Similarly, the second set of plurality of openings 212s are adapted to respective left side terminals 112l of a second set of plurality of cells 110s of the plurality of cells 110. The left side terminal 112l has a polarity opposite to that of the right-side terminal 112r. For example, the left side terminal 112l has a positive polarity and the right-side terminal has a negative polarity.

In an embodiment, each of the plurality of wire bonds 220 works as an electric fuse designed to disconnect/break when the current passing through any of the plurality of wire bonds 220 exceeds a predefined current value. The predefined current value depends upon the design aspects of the battery pack 200 such as number of cells, voltage, current, load connected, age of cells, duration of usage and the like. The wire bonds 220 may be designed and chosen with respect to the dimension and material based upon the required predefined current value and factor of safety as per the design aspects.

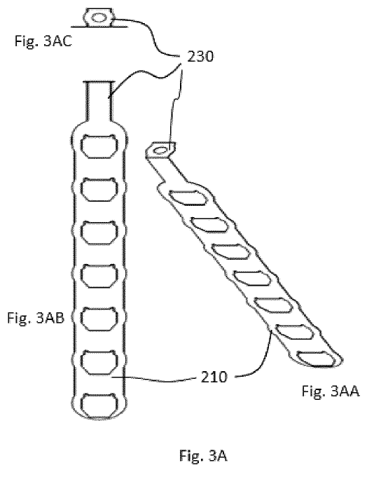

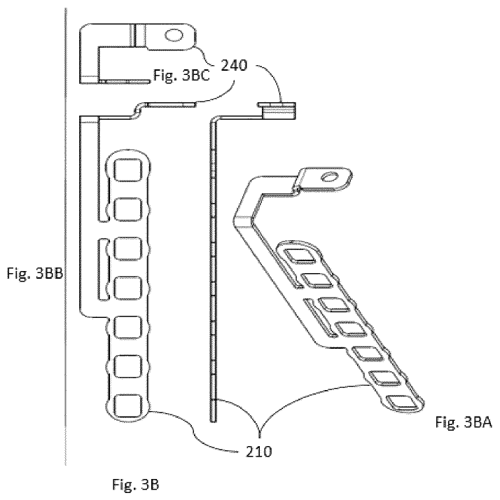

FIGS. 3A and 3B illustrate the interconnector 200 in various views in accordance with various different embodiments of the invention. FIG. 3AA illustrates the interconnector 200 in a perspective view. FIG. 3AB illustrates the interconnector 200 in a top view. FIG. 3AC illustrates the interconnector 200 in a front view. FIG. 3BA illustrates the interconnector 200 in a perspective view. FIG. 3BB illustrates the interconnector 200 in a top view. FIG. 3BC illustrates the interconnector 200 in a front view.

In an embodiment illustrated in FIG. 3A, the interconnector 200 only has the main interconnect segment 210 and the signal output subsegment 230. Alternatively, in FIG. 3B, in accordance with another embodiment, the interconnector 200 only has the main interconnect segment 210 and the busbar segment 240. The interconnector 200 thus provides a modular structure as per the arrangement of the cells 110 in the array of the battery pack 100.

In various embodiments of the invention, the interconnector 200 is made up of more than one type of metal such as copper, nickel and the like. For example, the main interconnect segment 210 and the busbar segment 240 are made of Copper and the signal output subsegment 230 is made of Nickel.

Advantageously, the interconnector provided by the invention obviates the use of spot welding for connecting the cells and increases battery safety from over current and short circuit. The problems of loose wires inherent in the spot-welding technique, which is the primary cause of short circuit is avoided by using wire bonding. The wires act as fuse such that if any cell behaves abnormally, the wires will break and disconnect that cell from the battery pack and notify the user about the pack and reducing the chances of thermal runaway.

Further, the invention also improves thermal management in the battery pack and avoids quality issues inherent with manual spot welding, since wire bonding process takes place at room temperature and no external heat is necessary. Wire bonding also has the advantage of single as well as dual side welding for improving the thermal management of the battery pack and reducing the weight of the pack for better handling and packaging.

Further, the interconnector provided by the invention is retrofittable and does not disturb the cell holder making and other child parts for effective bonding to happen between the interconnectors and the cells.

The invention also improves thermal management in the battery pack and avoids quality issues inherent with manual spot welding. Additionally, the weight of the battery pack is also reduced

Further, the invention provides a modular interconnector structure rather than a single plate. This improves the serviceability aspect of the battery pack.

While the present invention has been described with respect to certain embodiments, it will be apparent to those skilled in the art that various changes and modification may be made without departing from the scope of the invention as defined in the following claims.

1.-10. (canceled)

11. An interconnector for connecting a plurality of cells in a battery pack, the interconnector comprising:
a main interconnect segment for connecting the plurality of cells,
the main interconnect segment having a plurality of openings between a first end and a second end of the main interconnect segment,
the plurality of openings being adapted to respective terminals of the plurality of cells in the battery pack; and
a plurality of wire bonds connecting the main interconnect segment to the terminals of the plurality of cells,
the respective plurality of wire bonds at one end being connected to the terminals of the respective plurality of cells,
the respective plurality of wire bonds at another end being connected to a plurality of connecting portions on the main interconnect segment,
the plurality of connecting portions being substantially close to the respective terminals of the plurality of cells.

12. The interconnector as claimed in claim 11, further comprising:
a signal output sub-segment at the first end of the main interconnect segment, the signal output sub-segment being joined to the main interconnect segment providing information related to a state of the plurality of cells.

13. The interconnector as claimed in claim 12, wherein
the signal output sub-segment is made of Nickel and has means for connecting to an external monitoring instrument.

14. The interconnector as claimed in claim 11, further comprising:
a busbar segment running substantially parallel to the main interconnect segment, the busbar segment being joined to the main interconnect segment, the busbar segment extending towards and beyond the first end of the main interconnect segment for providing means for a power output of the plurality of cells.

15. The interconnector as claimed in claim 14, further comprising:
at least one twig portion connecting the main interconnect segment to the busbar segment, the at least one twig portion connecting the main interconnect segment to the busbar segment at a first location on the main interconnect segment.

16. The interconnector as claimed in claim 11, wherein
the plurality of openings includes a first set of plurality of openings and a second set of plurality of openings,
the first set of plurality of openings being disposed in a substantially straight line and running parallel to the second set of plurality of openings,
the first set of plurality of openings being adapted to a respective right-side terminal of a first set of plurality of cells of the plurality of cells and
the second set of plurality of openings being adapted to a respective left side terminal of a second set of plurality of cells of the plurality of cells,
the left side terminal having a polarity opposite to that of the right-side terminal, the first set of plurality of cells and
the second set of plurality of cells forming an array of cells in the battery pack.

17. The interconnector as claimed in claim 11, wherein
each of the plurality of wire bonds is an electric fuse designed to disconnect/break when a current passing through any of the plurality of wire bonds exceeds a predefined current value.

18. The interconnector as claimed in claim 17, wherein
the predefined current value depends upon the dimensions and a material of the wire bonds.

19. The interconnector as claimed in claim 11, wherein
the interconnector is made up of more than one type of metal.

20. The interconnector as claimed in claim 19, wherein
one of the metals is one chosen from a group comprising copper and nickel.
